(19) United States
(12) Patent Application Publication
(10) Pub. No.: US 2009/0037326 A1
(43) Pub. Date: Feb. 5, 2009

(54) Virtual Card Selector for a Portable Electronic Device

(76) Inventors: Sriram Chitti, Gurnee, IL (US); Greg R. Black, Vernon Hills, IL (US)

Correspondence Address: PHILIP H. BURRUS, IV, 460 Grant Street, Atlanta, GA, 30312, US

(21) Appl. No.: 12/040,709

(22) Filed: Feb. 29, 2008

Related U.S. Application Data
(60) Provisional application No. 60/952,660, filed on Jul. 30, 2007.

(51) Int. Cl. G06F 3/048; G06Q 20/00

(52) U.S. Cl. 705/39; 715/839; 715/812

(57) ABSTRACT

A portable electronic device (100), such as a mobile telephone, portable computer, personal digital assistant, or other similar device, is equipped with a virtual card application (101) configured to manage a plurality of virtual cards (106,107,108,109). Such virtual cards (106,107,108,109) are used in financial and other transactions by way of a wireless near-field transceiver (114) and a near-field communication terminal, such as a payment terminal (115). To provide a user with a seamless, less complex virtual card selection process, an arranger module (102) is configured to determine a priority associated with each of the virtual cards (106,107,108,109). The priority may be determined from location, schedule, calendar, user input, or other means. Once the priority is determined, the virtual card with the foremost priority is advanced as a top of the wallet card (111). The top of the wallet card (111), in one embodiment, is the default card for use in the transaction.

### CROSS REFERENCE TO PRIOR APPLICATIONS

This application claims priority and benefit under 35 U.S.C. §119(e) from U.S. Provisional Application No. 60/952,660, filed Jul. 30, 2007.

### BACKGROUND

1. Technical Field

This invention relates generally to virtual cards stored in a portable electronic device, and more specifically to a method and apparatus for arranging or selecting virtual cards stored within an electronic wallet.

2. Background Art

Due to rapidly advancing technology, paying for goods and services is becoming faster and more effortless. Not long ago, when a person wanted to purchase goods or services, they had to physically hand cash or a hand-written check to a cashier. The advent of magnetic striped credit cards simplified this process, as a person was able to “swipe” a credit card having a magnetic strip through a payment terminal in lieu of giving cash or a check to a cashier.

The advent of radio frequency “contactless” communication technology simplified the process even further. With contactless technology, rather than having to swipe a plastic card having an easily damaged magnetic strip through a narrow slot, a person is able to simply wave a card or key fob equipped with a hidden embedded computer chip and radio frequency antennae within an inch or two of a reader. Information, such as account number, expiration date, and account holder, is then transferred wirelessly to a reader to complete the financial transaction. When using such technology, to make the process even simpler, many merchants require no signature or personal identification number for small purchases, such as those less than twenty-five dollars.

Even with contactless technology, making purchases can be still somewhat cumbersome. For instance, when a user has multiple contactless-enabled cards in a wallet, the specific card to be used must be removed from the wallet and passed over the reader. Similarly, for the person who prefers key fobs, when that person carries multiple key fobs, the specific one used to make a purchase must be separated from the collection and passed over the reader.

There is thus a need for an improved system and method of executing electronic transactions.

### BRIEF DESCRIPTION OF THE DRAWINGS

FIG. 1 illustrates one embodiment of a portable electronic device having a virtual wallet and virtual card sorter in accordance with the invention.

FIG. 2 illustrates one method of sorting virtual cards in accordance with embodiments of the invention.

FIG. 3 illustrates one method of determining a priority associated with virtual cards in accordance with embodiments of the invention.

FIG. 4 illustrates another method of determining a priority associated with virtual cards in accordance with embodiments of the invention.

FIG. 5 illustrates another method of determining a priority associated with virtual cards in accordance with embodiments of the invention.

FIG. 6 illustrates another method of determining a priority associated with virtual cards in accordance with embodiments of the invention.

FIG. 7 illustrates another method of determining a priority associated with virtual cards in accordance with embodiments of the invention.

FIG. 8 illustrates one method for assigning a priority value to virtual cards in accordance with embodiments of the invention.

FIG. 9 illustrates an electronic device in accordance with embodiments of the invention detecting and reading an external object by way of a wireless near-field transceiver.

FIG. 10 illustrates a scheduling assignment of a default virtual card corresponding to a predetermined or historical schedule in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to selecting a “top of the wallet” virtual card from a plurality of virtual cards. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of assigning priorities to, or arranging in accordance with priorities of, virtual cards as described herein. The non-processor circuits may include, but are not limited to, a radio receiver, a near-field transceiver, a radio transmitter, signal drivers, clock circuits, power source circuits, and user input devices. As such, these functions may be interpreted as steps of a method to perform arrangement of virtual cards for display and use in a portable electronic device. Alternatively, some or all functions could be implemented by a state machine that has no stored program instructions, or in one or more application specific integrated circuits, in which each function or some combinations of certain of the functions are implemented as custom logic. Of course, a combination of the two approaches could be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and circuits with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Some mobile device manufacturers have recently developed electronic, or “virtual,” cards. For example, Mastercard®, in conjunction with some mobile phone manufacturers, offers a virtual “PayPass” card that is stored within the memory of a mobile telephone. In some embodiments of a mobile device, this card is stored within a secure memory, secure region of memory, or within a memory associated with a secure processor. Storage in within a secure element in the mobile device helps guard against unauthorized use of the information. The virtual card is loaded, installed, and personalized with card specific information, such as account number, name, expiration date, and one or more secure keys. The mobile device then transmits the information wirelessly to payment terminals via a near-field transceiver. The payment terminal is thus able to access the information and bill the user for a purchase.

As one virtual card can be stored within a device, so can others. To select the proper card to use, a user must navigate through a series of menus to find the virtual card application. Once in the application, the user must scroll through the various virtual cards and select the proper one. For some cards, additional information must be entered, including personal identification numbers and security codes. Such a process is cumbersome.

Embodiments of the present invention streamline the process and offer the user a more seamless experience with virtual cards. In one embodiment, the invention includes a “virtual wallet”, which includes a virtual card software application, running within the device, that hosts different cards (credit, loyalty, membership, identity, etc.). The virtual card application manages the virtual cards and permits user selection of the cards as well. The virtual wallet may further facilitate displaying the cards on a display in a wallet-type image.

An arranger is configured to automatically determine a priority of the cards based upon certain criteria. These criteria may include events in a calendar, location of the device, usage history, and so forth. Once this priority has been determined, the arranger then advances the card with the foremost priority to the “top of the wallet.” In other words, the top of the wallet card becomes in essence a default card that is used when the virtual card program is accessed. As such, unless a user deliberately selects another card, the default card will be selected for making transactions via a wireless near-field transceiver configured for near-field communication with a transaction terminal.

With embodiments of the present invention, a user simply places the portable electronic device near a near-field communication reader. The “top of the wallet” card is then used to make a transaction, for example at a point of sale at a merchant location. Additionally, the user may alternatively select any of the virtual cards as the top of wallet card as well.

In one embodiment, the top of wallet card is selected in accordance with a schedule, which may be determined from either a calendar application or a usage history. By way of example, a user may take a metropolitan subway to work every weekday at 8 AM. Once at work, perhaps at 9:30, the user may use his employee identification card to enter his office. Once in the office, the user may use a debit card to make purchases, such as lunch from the cafeteria or snacks from a vending machine. In the evening, he may go to dinner at a restaurant and use a credit card to pay for the meal. He may also have a diner loyalty card that he uses upon arriving at the restaurant to earn customer loyalty rewards.

In one embodiment, either by analyzing prior usage or by interfacing with a calendar program, the arranger determines a priority and advances the foremost priority card to the top as the top of the wallet card. Continuing with the example in the preceding paragraph, the arranger may select a subway transit virtual card as the top of the wallet card from 8 AM until, perhaps, 8:20 AM. From 8:30 AM until 4:30 PM, the top of the wallet card may be the employee identification virtual card, with the debit virtual card being advanced to the top of the wallet during lunch and snack times. On one particular Tuesday, perhaps in response to a calendar event corresponding to a restaurant reservation recorded in a calendar application, the credit virtual card becomes the top of the wallet card from 7 PM until 9 PM. As such, the arranger saves the user valuable steps in selecting which virtual card to use from the virtual card application.

In other embodiments, the arranger uses criteria other than schedule to determine priority and to advance the top of the wallet card. For instance, in one embodiment, location is used in determining which card should be the top of the wallet card. In such an embodiment, the portable electronic device stores a transaction history. The transaction history stores the card used and location for each transaction, as location can be determined from near-field posters or near-field communication readers. This location-transaction information is then used to automatically select a top of the wallet card that is the same card that was used in the previous visit to that location.

Embodiments of the invention also include user prompts. For instance, in one embodiment the user is asked whether they want to move a particular card to the top of wallet whenever entering this location. In another embodiment, the top of wallet selection may revert back to the default, which may be a calendar defined selection, after the transaction at the particular location occurs.

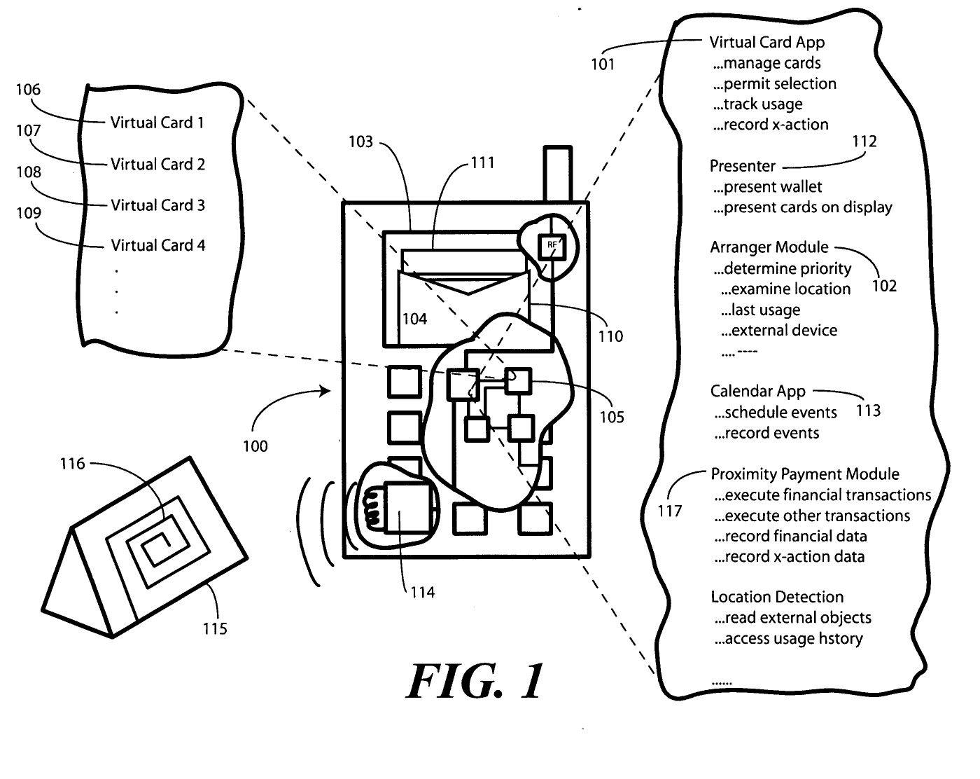

Turning now to FIG. 1, illustrated therein is one embodiment of a portable electronic device 100, such as a mobile telephone, having a virtual card application 101 and an arranger module 102 in accordance with the invention. While a mobile telephone will be used herein as an illustrative embodiment for discussion purposes, it will be clear to those of ordinary skill in the art having the benefit of this disclosure that the invention is not so limited. The virtual card application 101 and arranger module 102 may also be implemented in other portable electronic devices, including personal digital assistants, pagers, portable computers, and so forth.

Regarding hardware, the portable electronic device 100 includes a display 103 upon which information regarding device applications and device statuses may be presented. A controller 104, which in one embodiment is a microprocessor, is used to run applications stored in a memory 105. Note that while one microprocessor can be used as the controller 104, it will be clear to those of ordinary skill in the art having the benefit of this disclosure that embodiments of the invention are not so limited. The controller 104 in some embodiments can comprise a combination of microprocessors, programmable logic devices, or application specific integrated circuit devices. By way of example, in one embodiment the portable electronic device 100 includes a central processor and a secure processor. The central processor can be responsible for virtual wallet 110 operation, and may also store partial information associated with the virtual cards 106, 107,108,109 in its corresponding memory. For security purposes, other virtual card information may be stored within a secure processor and its memory, the secure processor operating in conjunction with the central processor. Other configurations may also be employed.

In addition to storing software applications, the memory 105 is also used for storing data, including the various virtual cards 106,107,108,109. These virtual cards may include any of an identification virtual card, a membership card, a debit virtual card, a credit virtual card, a transit virtual card, a loyalty virtual card, or a gift virtual card. It will be clear to those of ordinary skill in the art having the benefit of this disclosure that other virtual cards may be stored as well.

The controller 104 is configured to retrieve one or more of the plurality of virtual cards 106,107,108,109 and to then present them on the display 103. In one embodiment, these virtual cards 106,107,108,109 are presented on the display 103 as a virtual wallet 110. The virtual wallet 110, while optional, offers a familiar view of cards to the user. Further, where the display comprises a touch-sensitive display, a user may be able to make a manual selection from the virtual wallet 110 by simply touching the desired card.

The controller 104 is configured to present these cards on the display 103, in one embodiment, by software programs, operable with the controller 104 and stored within the memory 105. The controller 104 accesses the memory 105 to retrieve and execute these applications. The applications include a virtual card application 101, which is operable with the controller 104. The virtual card application 101 is configured to manage the various virtual cards 106,107,108,109. Further, the virtual card application 101 is configured to permit the user to select any of the virtual cards 106,107,108,109 as the top of the wallet card 111.

An arranger module 102 is configured to automatically select the top of the wallet card 111 based upon predetermined criteria. In one embodiment, the arranger module 102 is configured to determine a priority of the virtual cards 106,107,108,109. Once a priority is assigned to each of the virtual cards 106,107,108,109, the card with the foremost priority is advanced by the arranger module 102 to be the top of the wallet card 111. The controller 104 then presents at least some of the virtual cards, including the top of the wallet card 111, on the display 103. In one embodiment, a presenter module 112, which may be integrated with either the virtual card application 101 or the arranger module 102, is configured to present the graphical representation of the virtual cards on the display 103.

The arranger module 102 may employ any of a wide variety of criteria to determine priority. In one embodiment, a user's schedule is used as one criterion. The schedule, in one embodiment, is determined from a calendar application 113. The calendar application 113, which is operable with the arranger module 102, is used to schedule events and tasks entered into the portable electronic device 100 by the user. Where such events correspond to transactions, such as the restaurant reservation mentioned above, the arranger module 102 may detect such events to alter the priorities and the top of the wallet card 111.

For instance, in one embodiment the arranger module 102 is configured to determine the priority by detecting at least one event scheduled in the calendar application 113. When such an event is detected, the arranger module 102 determines a probable usage of a particular virtual card. By way of example, where a detected event is a repeat of a prior event, and a particular card was used during the prior event, the probable usage would likely be high. As such, when the arranger module assigns the probable usage to the particular card, that particular card may be advanced to the top of the wallet card 111.

In another embodiment employing schedule as a criterion, the arranger module 102 consults a virtual card usage history, stored in memory 105, to determine the priority. Such a method would be appropriate for the scheduling example set forth above. Where the usage history indicates that a transit virtual card is used every morning between 8 AM and 8:20 AM, the arranger module may assign a usage probability to the transit virtual card sufficient to advance the transit virtual card to become the top of the wallet card 111 during that time. Said another way, the arranger module 102 is configured to advance the virtual card priorities in accordance with the usage occurrences found in the usage history.

Once the top of the wallet card 111 is selected, be it by the arranger module 102 or the user, the top of the wallet card 111 may be used to make transactions by way of a wireless near-field transceiver 114. The wireless near-field transceiver 114, which in one embodiment is a form of radio-frequency identification device, is configured to send and receive radio-frequency data to remote devices. In the example of a financial transaction, the wireless near-field transceiver 114, which is operable with the controller 104, may communicate with a payment terminal 115 having a near-field communication reader 116 disposed therein. Information such as account number, user, and the like may be transmitted to the payment terminal 115. Purchase price, purchase location, date stamp, and confirmation number may be transmitted—in the case of a financial transaction—from the payment terminal to the wireless near-field transceiver 114.

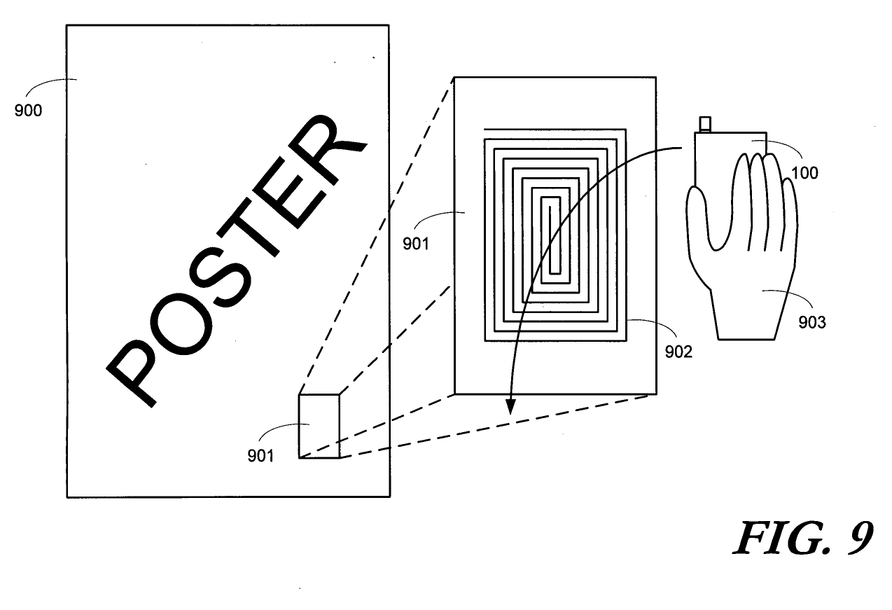

In addition to detecting devices such as payment terminals 115, the wireless near-field transceiver 114 may detect other objects as well. For instance, a newly developing technology is that of “smart posters.” A smart poster is a poster that includes a near-field communication tag capable of being read by the wireless near-field transceiver. A smart poster for a movie may include a near-field communication tag having information about show times, movie merchandise, and the like. When a user passes an electronic device having a wireless near-field transceiver within a predetermined distance of such a poster, the device may read the information and present corresponding information on the display. (A smart poster is illustrated and described in FIG. 9.)

To accommodate such situations, in one embodiment the wireless near-field transceiver 114 of the portable electronic device 100 is capable of reading such external objects. When the wireless near-field transceiver 114 detects the presence of an external device, such as a smart poster, the arranger module 102 is configured to determine a probable usage of one or more of the virtual cards 106,107,108,109. Where the external object is a smart poster, for example, the arranger module 102 may assign a high probable usage to the credit virtual card, as the arranger module may anticipate that a movie ticket is about to be purchased. The arranger module 102 therefore advances the credit virtual card in priority, and may make the credit virtual card the top of the wallet card 111.

In one embodiment, the arranger module 102 uses location information to determine priority and the corresponding top of the wallet card 111. Such location information may be retrieved from, for example, a payment terminal 115 or another external device such as a smart poster. When the wireless near-field transceiver 114 detects such an external object, the controller 104 is configured to determine location based upon information read from the external object. Once the location is known, in one embodiment, the arranger module 102 is configured to determine a priority based upon the location information, and to rearrange the virtual cards 106,107,108,109 accordingly.

A proximity payment module 117, which is operable with the controller 104 and the wireless near-field transceiver 114, is configured to execute financial transactions using at least one of the virtual cards 106,107,108,109. Thus, the proximity payment module 117 may transmit, for example, the account information and then receive a record of the transaction to store in memory 105.

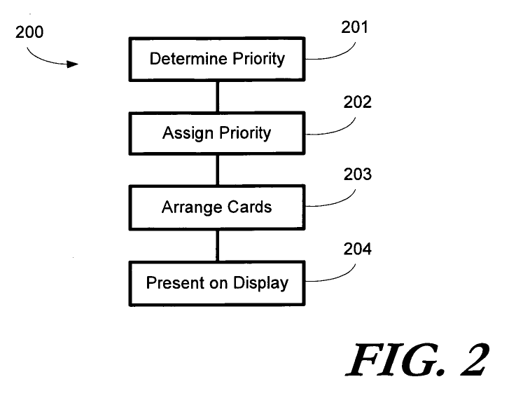

Turning now to FIG. 2, illustrates therein is one method 200 for presenting at least some of a plurality of virtual cards (106,107,108,109) on a portable electronic device (100) in accordance with embodiments of the invention. Such a method 200 is suitable, for example, of being implemented by the controller (104) through the execution of software code, perhaps as stored within the virtual card application (101).

At step 201, priority values associated with each of the virtual cards (106,107,108,109) are determined. As noted above, such values may stem from location information, usage history, scheduling, calendar applications, other means, or combinations thereof. Once the priority values have been determined, the method (200) assigns each of the virtual cards (106,107,108,109) a corresponding priority value at step 202. The virtual cards (106,107,108,109) are then arranged, according to priority, at step 203. Another application, or perhaps a module within a single application, then presents at least some of the virtual cards (106,107,108,109) on a display (103) in accordance with their priority values. The top virtual card, which is the virtual card having the foremost priority, is known as the top of the wallet card (111) and serves as the default card when the portable electronic device (100) is used to make financial or other transactions. In one embodiment, the virtual cards (106,107,108,109) are presented in a virtual wallet (110) on the display.

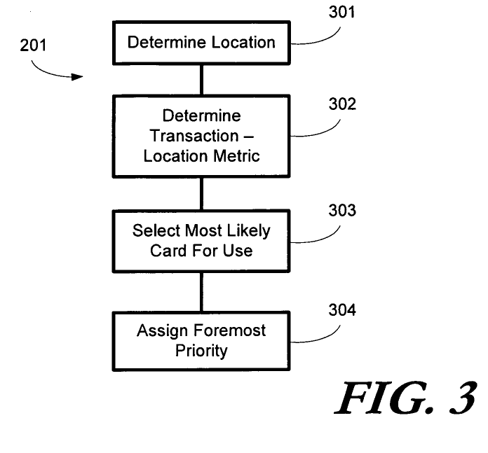

Turning now to FIG. 3, illustrated therein is one embodiment of determining priority 201 where the priority is based at least in part on location. At step 301, location is monitored and determined. This may be accomplished in a variety of ways. For instance, the portable electronic device (100) may be equipped with location circuitry such as a global positioning system receiver or an assisted global positioning system receiver. Alternatively, location may be obtained when a wireless near-field reader detects an external object such as a smart poster or payment terminal that includes location information.

Once the location is determined, the method 200 determines a transaction-location metric at step 302. A transaction-location metric may be a probability of use of a particular virtual card, and may be based upon both location and usage history. Additionally, the transaction-location metric may additionally take into consideration information read from external objects. For instance, if the payment terminal (115) only accepts one type of virtual card, the transaction-location metric for that card will be strong while the transaction-location metric of the other cards will be weak.

After determining the transaction-location metric, the most likely virtual card for use is selected at step 303. This virtual card may be selected solely from the transaction-location metric, although other factors may be used as well. For instance, if a user has selected to only use one particular card at a particular location, say for example only using a debit virtual card at the movies, this information may be taken into account as well.

Once the most likely virtual card for use has been selected, in one embodiment it is assigned the foremost priority at step 304. This assignment causes this virtual card to move to the top of the wallet, and to become the default card so long as the portable electronic device (100) remains in that location.

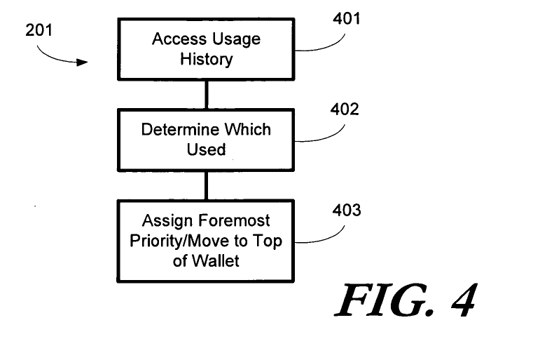

Turning now to FIG. 4, illustrated therein is an alternate method of determining priority 201. In the method of FIG. 4, virtual card usage history is used to determine priority. In one embodiment, the frequency of use of each virtual card is considered. In another embodiment, virtual card use and location of use is considered. User defined preferences, either as they relate to frequency of use or location, may also be considered. For instance, if a user desires to only use a credit virtual card offering frequent flier bonus miles when purchasing gasoline, that user preference is considered.

At step 401, the usage history of the portable electronic device (100) is considered. In one embodiment, the portable electronic device (100) stores a log of the use of each virtual card and, where possible, the location of use in memory (105). At step 401 the method (200) retrieves this information.

At step 402, the method (200) determines which virtual card is appropriate to advance in priority based upon the usage history. This may be determined in a variety of ways, as noted above. Once the virtual card has been selected, it is advanced in priority at step 403.

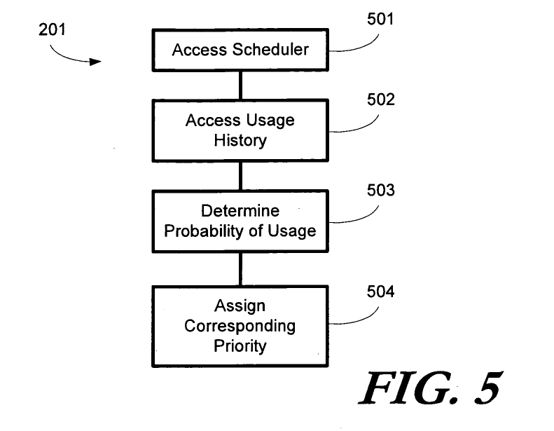

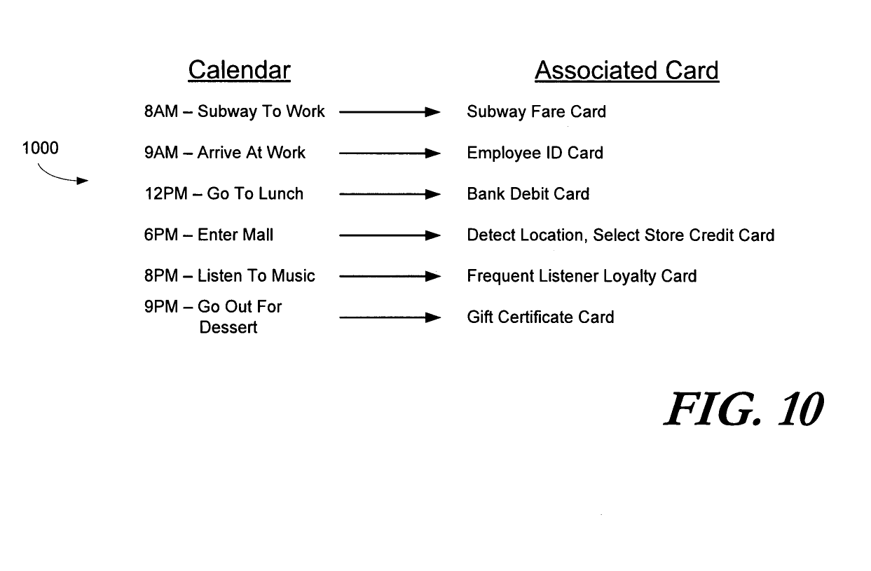

Turning now to FIG. 5, illustrated therein is an alternate method of determining priority 201 based upon a schedule. As noted above, both a calendar and a derived schedule from usage history may be used to determine a factor of priority for the virtual cards. In one embodiment, the method (200) employs events booked in a calendar—such as restaurant reservations, vacation plans, and the like. In another embodiment, a user defined or usage history derived schedule is used. For instance, a user may take a metropolitan subway to work every weekday at 8 AM, use his employee identification card to enter his office at 9:30, use a debit card to make purchases at lunch at noon, use a credit card to pay for the dinner at 8 PM. (FIG. 10 illustrates one exemplary usage history 1000 that may be stored in memory (105).)

At step 501, the method (200) accesses the scheduler, which may include the calendar application (113), the usage history, or both. For example, the usage history is accessed at step 502. From the scheduler information, usage history information, or both, a probability of usage is determined at step 503.

There will be instances where even though a virtual card was used at a particular location in accordance with a schedule, its probability will be low. For example, where a user has a virtual transit card, but the number of fares remaining on the virtual transit card was insufficient to board the subway, a user may have used a credit card to purchase more fares. Thus, when in the subway station at 8 AM, the number of uses of the transit virtual card may have been 27 in the last 30 occurrences, while the number of uses of the credit virtual card was 3. In such a situation, the transit virtual card will have a greater probability of usage than will the credit virtual card. The credit virtual card, however, having been used three times while a debit virtual card was used zero, will have a higher probability of usage than the debit virtual card.

Once the probability of usage has been determined, the probabilities are assigned to the virtual cards at step 504. This assignment allows the arranger module (102) to advance the proper virtual cards accordingly.

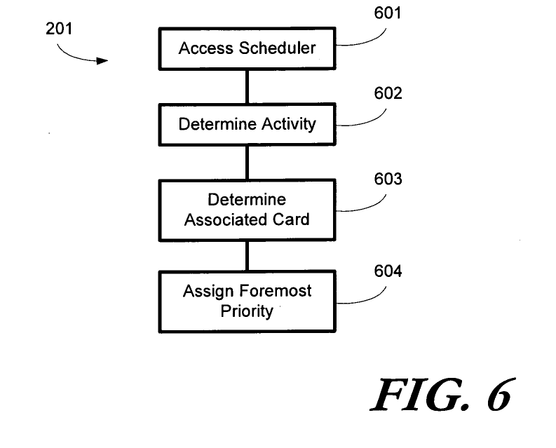

While the illustrative embodiment of FIG. 5 depicted a combination of both scheduler and usage history being used to determine priority, FIG. 6 illustrates an embodiment where the calendar application (113) only is used to determine priority. At step 601, the method (200) accesses the scheduler, which is the calendar application (113). At step 602, events logged in the calendar are detected. Such events may be programmed by the user.

At step 603, the method (200) determines the corresponding card. One method of doing so includes reviewing the calendar application (113) for other similar events. If the event is a restaurant reservation at Chez ABC, and the user used the credit virtual card the last time at Chez ABC, the method (200) associates this card with the event at step 603.

At step 604, the priority is assigned to the applicable card. Continuing with the example from the previous paragraph, if the user dined at Chez ABC four times in the past, and used the credit virtual card to pay for the meal three times, while using the debit virtual card once, the credit virtual card would have a higher priority than the debit virtual card. Both the debit and virtual card would have a higher priority than, for example, the transit virtual card that was never used at Chez ABC. Once the priorities are assigned, the arranger module (102) may advance the virtual card having the foremost priority to the top of the wallet card (111).

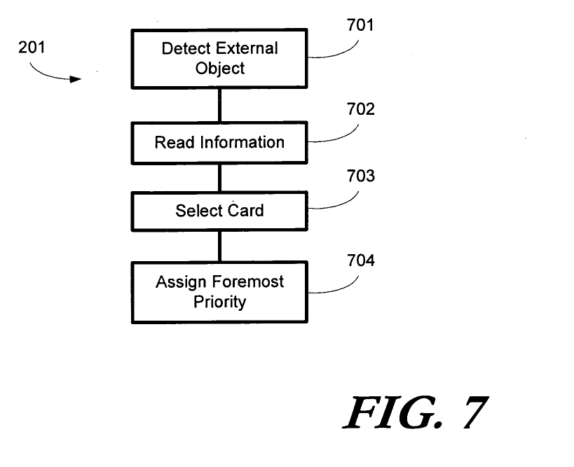

Turning now to FIG. 7, illustrated therein is an alternate embodiment of determining priority 201. In FIG. 7, location information detected from an external object is used to determine priority. Continuing with the restaurant example, suppose that there was no reservation—the user simply arrived at Chez ABC on the spur of the moment. Once at Chez ABC, however, the user plans to use one of the virtual cards stored in the portable electronic device (100) to pay for his meal. To do so, the user would pass the portable electronic device (100) over an external object, such as a payment terminal (115).

In the method of FIG. 7, this payment terminal is detected at step 701. Information from the payment terminal, such as the location or name of the vendor, is read at step 702. Once this information is known, the method (200) may recalculate priorities based upon usage history. If this is the fourth time at Chez ABC and the credit virtual card has been used three times, its priority will be advanced. The priorities of each of the cards are assigned at step 704.

Turning briefly to FIG. 9, illustrated therein is an exemplary portable electronic device 100 reading an external device to determine location. Specifically, in FIG. 9, the external device is a “smart poster” 900. The smart poster 900 may be used, for example, in the method of FIG. 7 to determine location. Where, for instance, the smart poster 900 is a movie poster in a theater, the portable electronic device 100 may read information from the smart poster 900 to determine that the current location is that of a movie theater.

The smart poster 900 looks like a traditional poster, but has at least one embedded near-field communication tag 901 coupled thereto. The embedded near-field communication tag 901 includes an device 902 capable of being read by the wireless near-field transceiver (114) within the portable electronic device 100. The user 903 simply passes the portable electronic device 100 near the embedded near-field communication tag 901 and the wireless near-field transceiver (114) reads the information.

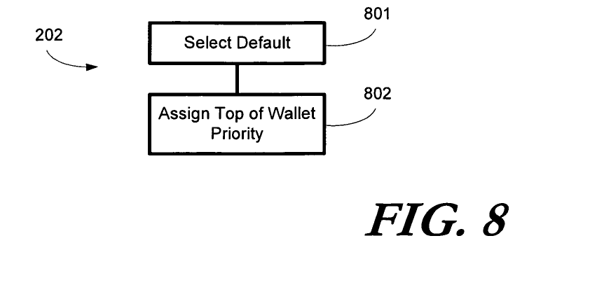

At any time of course, in one embodiment, the user may override automatic selection of the arranger module (102). Further, there may be times when two or more virtual cards have relatively equal priorities. For either situation, the user may elect to select a default virtual card. Such a method is shown in FIG. 8.

Turning now to FIG. 8, illustrated therein is one method of a user selecting a default virtual card to assign priority 202. At step 801, the user selects the default card. At step 802, the method (200) advances the default card. This advancement may be either per instructions from the user or for situations where one virtual card does not stand out as having the foremost priority.

In summary, embodiments of the invention provide a device and method to permit applications operating within an electronic device to select a top of the wallet card in accordance with various criteria, including a calendar method, a last card used method, a location method, or other methods. The top of the wallet card, in one embodiment, is the default card to be used when the electronic is used in a financial or other transaction, such as when it is waved at a near-field communication reader at a point of sale.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A portable electronic device having a display, comprising:
a memory configured to store a plurality of virtual cards;
a controller, operable with the memory, configured to retrieve at least the plurality of virtual cards from the memory and to present at least some of the plurality of virtual cards on the display;
a virtual card application, operable with the controller, and configured to manage the plurality of virtual cards and permit user selection of at least one of the plurality of virtual cards; and
an arranger module, operable with the controller, configured to determine a priority of each of the plurality of virtual cards;
wherein the controller is configured to present the at least some of the plurality of virtual cards on the display in accordance with the priority.

2. The portable electronic device of claim 1, wherein the controller is configured to present the at least some of the plurality of virtual cards on the display as a virtual wallet.

3. The portable electronic device of claim 2, wherein a default virtual card having foremost priority selected from the plurality of virtual cards is presented at a top of the virtual wallet.

4. The portable electronic device of claim 3, wherein the plurality of virtual cards comprises at least one of an identification virtual card, a membership card, a debit virtual card, a credit virtual card, a transit virtual card, a loyalty virtual card, or a gift virtual card.

5. The portable electronic device of claim 1, further comprising a calendar application, operable with the arranger module, wherein the arranger module is configured to determine the priority by detecting at least one event scheduled in the calendar application, the at least one event corresponding to a probable usage of at least one of the plurality of virtual cards.

6. The portable electronic device of claim 1, further comprising a wireless near-field transceiver operable with the controller, wherein the arranger module is configured such that upon the wireless near-field transceiver detecting a presence of an external device corresponding to a probable usage of one or more of the plurality of virtual cards, the arranger module is configured to advance the one or more of the plurality of virtual cards in priority.

7. The portable electronic device of claim 1, wherein the arranger module is configured to detect usage occurrences of any of the plurality of virtual cards, and to advance virtual card priorities in accordance with the usage occurrences.

8. The portable electronic device of claim 1, further comprising a wireless near-field transceiver, operable with the controller, wherein the controller is configured to determine location information from objects detected by the wireless near-field transceiver, wherein the arranger module is configured such that upon the controller detecting location information, the arranger module determines the priority based upon at least the location information.

9. The portable electronic device of claim 1, further comprising a further comprising:
a wireless near-field transceiver operable with the controller; and
a proximity payment module operable with the wireless near-field transceiver and configured to execute financial transactions using at least one of the plurality of virtual cards;
wherein the arranger module is configured to select default virtual card for use in the financial transactions in accordance with a predetermined schedule.

10. A portable electronic device of claim 1, further comprising a wireless near-field transceiver operable with the controller, wherein the wireless near-field transceiver comprises a radio-frequency identification device.

11. A method of presenting at least some of a plurality of virtual cards on a portable electronic device having a display, the method comprising the steps of:
determining priority values associated with each of the plurality of virtual cards;
assigning each of the plurality of virtual cards a corresponding priority value; and
presenting the at least some of the plurality of virtual cards on the display according to their corresponding priority values.

12. The method of claim 11, wherein the step of presenting the at least some of the plurality of virtual cards on the display comprises presenting the at least some of the plurality of virtual cards in a virtual wallet.

13. The method of claim 12, wherein the step of presenting the at least some of the plurality of virtual cards on the display comprises presenting a virtual card having a foremost priority on the top of the virtual wallet.

14. The method of claim 11, further comprising the step of monitoring a location of the portable electronic device, wherein the step of determining priority values associated with each of the plurality of virtual cards is dependent upon the location.

15. The method of claim 14, further comprising the step of determining a transaction-location likelihood metric associated with each of the plurality of virtual cards, wherein the step of determining priority values associated with each of the plurality of virtual cards comprises using the transaction-location likelihood metric associated with each of the plurality of virtual cards.

16. The method of claim 15, wherein the step of presenting at least some of the plurality of virtual cards on the display according to their corresponding values comprises presenting a virtual card having a foremost priority at a top of a virtual wallet.

17. The method of claim 11, wherein the step of determining priority values associated with each of the plurality of virtual cards comprises determining which of the plurality of virtual cards was used most recently.

18. The method of claim 11, wherein the step of determining priority values associated with each of the plurality of virtual cards comprises determining a time of day and a virtual card usage history, and associating a probability of use with each of the plurality of virtual cards based upon the time of day and the virtual card usage history.

19. The method of claim 11, wherein the portable electronic device comprises a scheduling application, further comprising the step of accessing the scheduling application, wherein the step of determining priority values associated with each of the plurality of virtual cards comprises associating events in the scheduling application with virtual cards associated with those events.

20. The method of claim 11, further comprising the step of determining a default virtual card and presenting the default virtual card on the display as a top virtual card in a virtual wallet.
